(19) United States
(12) Patent Application Publication
(10) Pub. No.: US 2009/0046783 A1
(43) Pub. Date: Feb. 19, 2009

(54) Method and Related Device for Decoding Video Streams

(76) Inventors: Chien-Chih Chen, Hsinchu City (TW); Yu-Ling Ko, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/838,236

(22) Filed: Aug. 14, 2007

(51) Int. Cl. H04N 7/24

(52) U.S. Cl. 375/240.24; 375/E07.021

(57) ABSTRACT

A method for decoding a picture of a video stream includes decoding the video stream by a video decoder for generating a plurality of macroblocks corresponding to the picture, macroblock information corresponding to the plurality of macroblocks, and picture information corresponding to the picture; storing the macroblock information and the picture information into a memory buffer; and determining whether the picture is needed to be performed a de-blocking process by the video decoder according to the macroblock information and the picture information stored in the memory buffer.

### BACKGROUND OF THE INVENTION

1. Field of the Invention

The present invention related to a method and related device for decoding video streams, and more particularly, to a method and related device capable of enhancing the efficiency of the de-blocking filtering process and saving system memory bandwidths by storing the macroblock information and the picture information generated by a video decoder into a memory buffer.

2. Description of the Prior Art

A wide range of new applications in visual communications have been made possible due to the rapidly evolving telecommunication and computer industries. Almost all the related applications, including video conferencing, mobile or PSTN video telephony, video over the Internet, and digital TV broadcasting, require very efficient data compression methods to fit a large amount of visual information into the narrow bandwidth of communication channels while preserving acceptable quality of the reconstructed data.

To efficiently compress a time variable video sequence, redundancy in the temporal domain as well as in the two dimensional spatial domain must be reduced. The Moving Picture Experts Group (MPEG) standards use a discrete cosine transform (DCT) for processing the steps of reducing the redundancy in the two dimensional spatial domain and a motion estimation method for processing the steps of reducing the redundancy in the temporal domain.

The prior art video compression technique performs DCT operations, if necessary, after input data is sampled into 8×8 units, and DCT coefficients are quantized with respect to a visual property using quantization parameters from a quantization table. Then, the data is compressed through a run length coding (RLC). The data processed with DCT is converted from a spatial domain to a frequency domain and compressed with the quantization parameters corresponding to the visual property of human beings, not to be visually recognized. For example, since human eyes are insensitive to high frequency images, a high frequency coefficient is quantized using a large step size. Thus, a quantization table is made according to external parameters, such as a display characteristic, watching distance, and noise, to perform an appropriate quantization.

Please refer to FIG. 1. FIG. 1 shows a plurality of adjacent 8×8 pixel blocks 100, 102, 104 used according to the above described MPEG compression. In processing a moving picture as discussed above, these blocks 100, 102, 104 are individually processed to maximize the compression ratio and coding efficiency. However, this individual processing causes blocking artifacts that are noticeable at boundaries between blocks because of DCT and quantization effect. Both horizontal block boundaries 106 and vertical block boundaries 108 are present and tend to cause square patterns (i.e. blocking artifacts) that are quite apparent to the human eye.

In the traditional block-based video compression standards such as MPEG-2, the blocking artifact is the most noticeable artifact. Thus, various methods for reducing blocking artifacts in decoding systems that individually processes blocks have been developed. Generally speaking, among these methods, the decoding process and the de-blocking process are separately implemented when decoding a moving picture from a video stream. That is, after a picture construction process is performed for an entire decoded picture, a de-blocking process including de-blocking detection and recovery is then performed on each macroblock of the picture according to picture information and macroblock information corresponding to the picture. However, in reality, the picture information and the macroblock information corresponding to the picture is already decoded and discarded during the decoding process, and thus the de-blocking process costs extra system resources for decoding the related information again. Furthermore, if image quality of a decoded picture is acceptable enough, or most of the macroblocks of the decoded picture does not have significant blocking artifact, performing the de-blocking process for the decoded picture is not necessary.

Therefore, in a prior art image decoding system, since the MPEG decoding process and the de-blocking process are implemented separately, some information, such as the macroblock information and the picture information, is decoded repeatedly and more calculation time is consumed as well, so that the efficiency of the de-blocking process cannot be optimized. However, the demand for de-blocking filtering of MPEG-encoded video is increasing due to the wide acceptance of MPEG applications, such as digital versatile discs (DVDs) and digital TV.

### SUMMARY OF THE INVENTION

It is therefore a primary objective of the present invention to provide a method and related device for decoding video streams.

The present invention discloses a method for decoding a picture of a video stream. The method includes decoding the video stream by a video decoder for generating a plurality of macroblocks corresponding to the picture, macroblock information corresponding to the plurality of macroblocks, and picture information corresponding to the picture; storing the macroblock information and the picture information into a memory buffer; and determining whether the picture is needed to be performed a de-blocking process by the video decoder according to the macroblock information and the picture information stored in the memory buffer.

The present invention further discloses a video-decoding device for decoding a picture of a video stream. The video decoding device includes a video decoder including a decoding unit for decoding the video stream to generate a plurality of macroblocks forming the corresponding picture and generate macroblock information and picture information corresponding to the plurality of macroblocks and the picture, and a determination unit for determining whether the picture needed to be performed a de-blocking process according to the macroblock information and the picture information; and a memory buffer for storing the macroblock information and the picture information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a plurality of adjacent 8×8 pixel blocks used according to the above described MPEG compression.

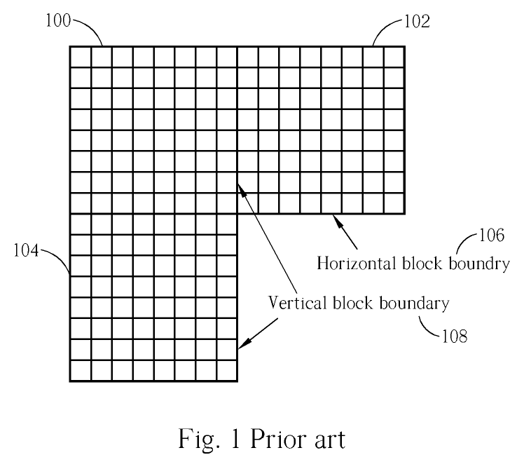

FIG. 2 is a schematic diagram of a process for decoding a picture of a video stream according to the present invention.

FIG. 3 is a function block diagram of a video decoding device of the present invention for decoding a picture of a video stream.

FIG. 4 is a schematic diagram of a process for determining whether the picture is needed to be performed the de-blocking filtering process according to a first embodiment of the present invention.

FIG. 5 is a schematic diagram of a process for determining whether the picture is needed to be performed the de-blocking process according to a second embodiment of the present invention.

### DETAILED DESCRIPTION

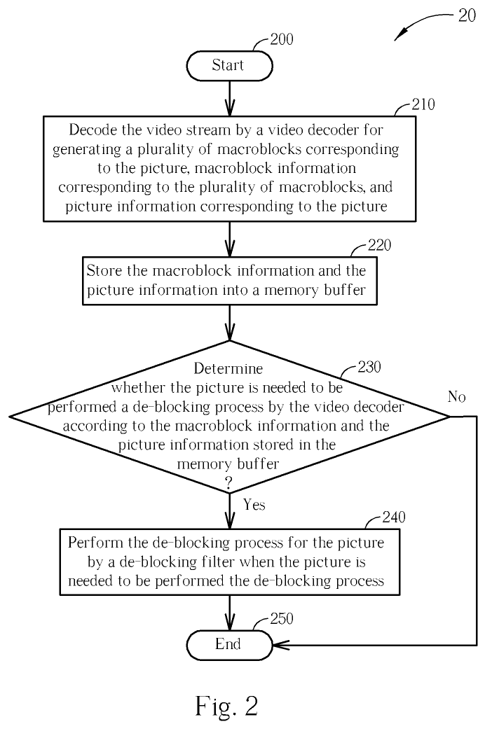

Please refer to FIG. 2. FIG. 2 is a schematic diagram of a process 20 for decoding a picture of a video stream according to the present invention. The process 20 is utilized for an image decoding system according to MPEG (Motion Picture Expert Group) 2 standard, and includes the following steps:

Step 200: start.

Step 210: decode the video stream by a video decoder for generating a plurality of macroblocks corresponding to the picture, macroblock information corresponding to the plurality of macroblocks, and picture information corresponding to the picture.

Step 220: store the macroblock information and the picture information into a memory buffer.

Step 230: determine whether the picture is needed to be performed a de-blocking process by the video decoder according to the macroblock information and the picture information stored in the memory buffer.

Step 240: perform the de-blocking process for the picture by a de-blocking filter when the picture is needed to be performed the de-blocking process.

Step 250: end.

According to the process 20, the present invention first decodes the video stream by the video decoder for generating a plurality of macroblocks corresponding to the picture, macroblock information corresponding to the plurality of macroblocks, and picture information corresponding to the picture. Certainly, the picture can be formed according to the plurality of macroblocks after the completion of a picture construction process. Then, the present invention stores the macroblock information and the picture information into a memory buffer, and thus the video decoder can determine whether the picture is needed to be performed a de-blocking process according to the macroblock information and the picture information stored in the memory buffer. When the decoded picture is needed to be performed the de-blocking process, the present invention then performs the de-blocking process for the picture by a de-blocking filter of the image decoding system, and outputs a processing result for display. Note that, the video stream can be a data stream read out from a digital versatile disc (DVD), and the video decoder can be an MPEG decoder.

Preferably, the macroblock information can include discrete cosine transform (DCT) types, quantization parameters, and macroblock (MB) error bits, among which the DCT types and the quantization parameters can be directly decoded from the video stream, while the MB error bits can be obtained when the video decoder performs an error detection process for each of the plurality of the macroblocks. On the other hand, the picture information can include parameters of picture structure, frame types, horizontal picture size and vertical picture size, and can all be directly decoded from the video stream as well.

Therefore, by storing the macroblock information and the picture information generated by the video decoder into the memory buffer, the present invention can obtain the related information for de-blocking detection and recovery through directly accessing the memory buffer when the decoded picture is needed to be performed the de-blocking process, and thus such information need not to be decoded repeatedly any longer, so as to enhance the efficiency of the de-blocking process. Besides, the present invention can determine whether the picture is needed to be performed the de-blocking process in advance according to the macroblock information and the picture information stored in the memory buffer, and the picture with high image quality can be saved an unnecessary de-blocking detection and recovery, so that the system resource such as memory bandwidths can be saved.

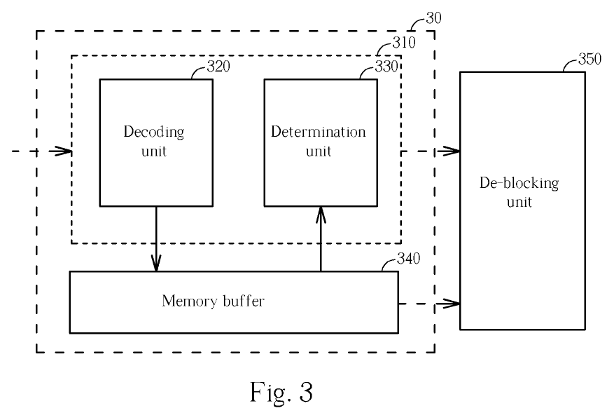

Please refer to FIG. 3. FIG. 3 is a function block diagram of a video decoding device 30 of the present invention for decoding a picture of a video stream. The video decoding device 30 includes a video decoder 310 and a memory buffer 340, wherein the video decoder 310 further includes a decoding unit 320 and a determination unit 330. The decoding unit 320 is preferred to be a MPEG-2 decoder, and is utilized for decoding the video stream to generate a plurality of macroblocks forming the corresponding picture and generate macroblock information and picture information corresponding to the plurality of macroblocks and the picture respectively. The determination unit 330 is utilized for determining whether the picture is needed to be performed a de-blocking process according to the macroblock information and the picture information. The memory buffer 340, coupled to the decoding unit 320 and the determination unit 330, is utilized for storing the macroblock information and the picture information. In addition, a de-blocking unit 350 is coupled to the video decoding device 30, and is utilized for performing a de-blocking process when the decoded picture is needed to be performed the de-blocking process determined by the determination unit 330. Note that, the video decoding device 30 is utilized for realizing the process 20, and thus the related operation will not be narrated in detail. Certainly, those skilled in the art can further implement with any hardware and firmware or make appropriate modifications according to practical demands, which are still in the range of the present invention.

Therefore, through the video decoding device 30, the present invention can enhance the efficiency of the de-blocking process, and can save the system resource such as memory bandwidths as well.

Preferably, the video decoder can determine whether the picture is needed to be performed a de-blocking process according to the quantization parameters of the macroblock information stored in the memory buffer. When a picture having a high image quality (i.e. the quantization parameters of the picture are small) is performed the de-blocking filtering process, the image quality of the processed picture will not become better, but lose its original high quality, such as a blur image in the picture. Thus, to prevent a high image quality picture from an unnecessary de-blocking detection and recovery, there are two exemplary embodiments of the present invention in the following.

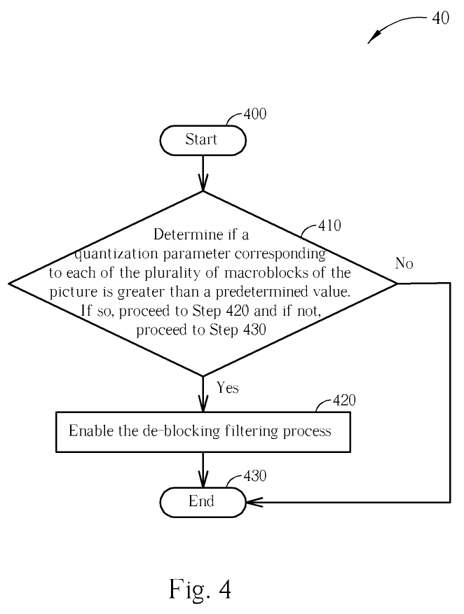

Please refer to FIG. 4. FIG. 4 is a schematic diagram of a process 40 for determining whether the picture is needed to be performed the de-blocking filtering process according to a first embodiment of the present invention. The process 40 includes the following steps:

Step 400: start.

Step 410: determine if a quantization parameter corresponding to each of the plurality of macroblocks of the picture is greater than a predetermined value. If so, proceed to Step 420; and if not, proceed to Step 430.

Step 420: enable the de-blocking filtering process.

Step 430: end.

Therefore, according to the process 40, the present invention determines in order whether a quantization parameter of each of the macroblock is greater than a predetermined value. When the quantization parameter of one of the plurality of macroblocks is greater than the predetermined value, the present invention then enable the de-blocking filter to perform the de-blocking filtering process for the picture. In other words, if the quantization parameters corresponding to each of the plurality of macroblocks in the picture are all smaller than the predetermined value, meaning that the image quality of the decoded picture is good enough, the de-block filter will not process this picture, so as to save the related memory bandwidths. Please note that, those skilled in the art can set the predetermined value according to practical demands, and thus the predetermined value is not restricted to a specific value.

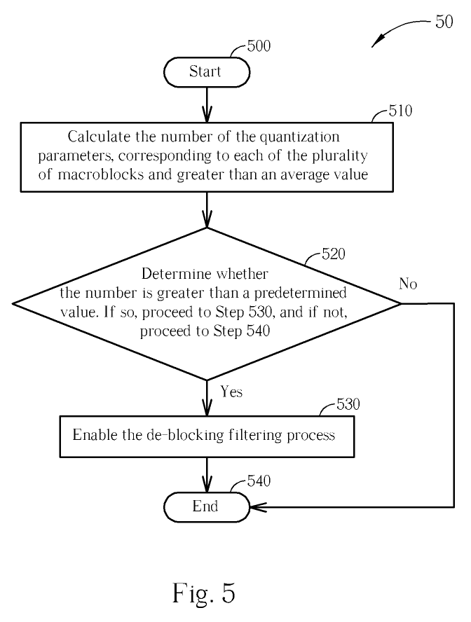

Please further refer to FIG. 5. FIG. 5 is a schematic diagram of a process 50 for determining whether the picture is needed to be performed the de-blocking process according to a second embodiment of the present invention. The process 50 includes the following steps:

Step 500: start.

Step 510: calculate the number of the quantization parameters, corresponding to each of the plurality of macroblocks and greater than an average value.

Step 520: determine whether the number is greater than a predetermined value. If so, proceed to Step 530, and if not, proceed to Step 540.

Step 530: enable the de-blocking filtering process.

Step 540: end.

According to the process 50, the present invention first calculates the number of the quantization parameters, corresponding to each of the plurality of macroblocks and greater than the average value of all of the quantization parameters corresponding to the plurality of macroblocks. When the number of the quantization parameters greater than the average value is greater than the predetermined value, the present invention then enables the de-blocking filter to perform the de-blocking filtering process for the picture. Conversely, when the number is smaller than the predetermined value, meaning that the image quality of the decoded picture is good enough, the de-block filter will not process this picture to save the memory bandwidths. In like manners, the predetermined value is adjustable, and can be set according to practical demands.

As mentioned above, the present invention can determine whether the picture is needed to be performed the de-blocking process in advance according to the quantization parameters of the macroblock information stored in the memory buffer. In addition, through directly accessing the memory buffer, the present invention can efficiently perform the de-blocking filtering process for the picture that is necessary to be performed the de-blocking filtering process according to the macroblock information and the picture information stored in the memory buffer. Therefore, the present invention not only can enhance the efficiency of the de-blocking filtering process, but can save the system resources such as memory bandwidths as well.

Those skilled in the art will readily observe that numerous modifications and alterations of the device and method may be made while retaining the teachings of the invention.

What is claimed is:

1. A method for decoding a picture of a video stream comprising:
decoding the video stream by a video decoder for generating a plurality of macroblocks corresponding to the picture, macroblock information corresponding to the plurality of macroblocks, and picture information corresponding to the picture;
storing the macroblock information and the picture information into a memory buffer; and
determining whether the picture is needed to be performed a de-blocking process by the video decoder according to the macroblock information and the picture information stored in the memory buffer.

2. The method of claim 1 further comprising:
performing the de-blocking process for the picture by a de-blocking filter when the picture is needed to be performed the de-blocking process.

3. The method of claim 2, wherein performing the de-blocking process for the picture by the de-blocking filter is performing the de-blocking process for the picture by the de-blocking filter according to the macroblock information and the picture information stored in the memory buffer.

4. The method of claim 1, wherein determining whether the picture is needed to be performed the de-blocking process by the video decoder according to the macroblock information and the picture information stored in the memory buffer is determining whether the picture is needed to be performed the de-blocking process by the video decoder according to quantization parameters of the macroblock information corresponding to the plurality of macroblocks stored in the memory buffer.

5. The method of claim 4, wherein determining whether the picture is needed to be performed the de-blocking process by the video decoder according to the quantization parameters of the macroblock information stored in the memory buffer comprises determining that the picture is needed to be performed the de-blocking process by the video decoder when a quantization parameter corresponding to one of the plurality of macroblocks is greater than a predetermined value.

6. The method of claim 4, wherein determining whether the picture is needed to be performed the de-blocking process by the video decoder according to the quantization parameters of the macroblock information stored in the memory buffer comprises determining that the picture is needed to be performed the de-blocking process by the video decoder when the number of the quantization parameters greater than an average value is greater than a predetermined value.

7. The method of claim 1, wherein the video stream is formed according to MPEG (Motion Picture Expert Group) 2 standard.

8. The method of claim 1, wherein the macroblock information comprises quantization parameters, macroblock error bits, and DCT (Discrete Cosine Transform) types corresponding to each of the plurality of macroblocks.

9. The method of claim 1, wherein the picture information comprises a picture structure, a horizontal picture size, a vertical picture size, and frame types corresponding to the picture.

10. A video decoding device for decoding a picture of a video stream comprising:
a video decoder comprising:
a decoding unit for decoding the video stream to generate a plurality of macroblocks forming the corresponding picture and generate macroblock information and picture information corresponding to the plurality of macroblocks and the picture; and
a determination unit for determining whether the picture needed to be performed a de-blocking process according to the macroblock information and the picture information; and
a memory buffer for storing the macroblock information and the picture information.

11. The video decoding device of claim 10 further comprising a de-blocking filter for performing the de-blocking process for the picture when the picture is needed to be performed the de-blocking process.

12. The video decoding device of claim 11, wherein the de-blocking filter is utilized for performing the de-blocking process for the picture by the de-blocking filter according to the macroblock information and the picture information stored in the memory buffer.

13. The video decoding device of claim 10, wherein the determination unit is utilized for determining whether the picture needed to be performed the de-blocking process according to quantization parameters of the macroblock information corresponding to each of the plurality of macroblocks stored in the memory buffer.

14. The video decoding device of claim 13, wherein the determination unit is utilized for determining the picture needed to be performed the de-blocking process when the quantization parameter of one of the plurality of macroblocks is greater than a predetermined value.

15. The video decoding device of claim 13, wherein the determination unit is utilized for determining the picture needed to be performed the de-blocking process when the number of the quantization parameters greater than an average value is greater than a predetermined value.

16. The video decoding device of claim 10, wherein the video stream is formed according to a standardization of MPEG (Motion Picture Expert Group) 2 standard.

17. The video decoding device of claim 10, wherein the macroblock information stored in the memory buffer comprises quantization parameters, macroblock error bits, and DCT (Discrete Cosine Transform) types corresponding to each of the plurality of macroblocks.

18. The video decoding device of claim 10, wherein the picture information stored in the memory buffer comprises a picture structure, a horizontal picture size, a vertical picture size, and frame types corresponding to the picture.
